(19) United States
(12) Patent Application Publication
(10) Pub. No.: US 2009/0042160 A1
(43) Pub. Date: Feb. 12, 2009

(54) ORTHODONTIC ARCH WIRE

(76) Inventor: Alon Ofir, Irvine, CA (US)

Correspondence Address: MARC E. HANKIN, ESQ., 11414 THURSTON CIRCLE, LOS ANGELES, CA, 90049, US

(21) Appl. No.: 11/837,414

(22) Filed: Aug. 10, 2007

(51) Int. Cl. A61C 7/12

(52) U.S. Cl. 433/20

(57) ABSTRACT

An orthodontic arch wire having an oval or elliptical cross section. The orthodontic arch wire is configured such that the major axis of the orthodontic arch wire is orientated generally perpendicularly to the face of the tooth.

### FIELD OF INVENTION

Various embodiments of this invention relate, generally, to orthodontic arch wires; more particularly, to a novel orthodontic arch wire having an oval cross-sectional shape.

### BACKGROUND

In the art of orthodontic procedures, orthodontic arch wires (“arch wires”) are commonly used in conjunction with brackets in order to adjust the position of maloccluded teeth. Various cross-sectional shapes and thicknesses of arch wires are known in the art in order to achieve different results depending on the particular goals of the treating orthodontist. The various shapes and thicknesses of arch wires, while offering certain advantages, usually also have certain disadvantages. Thus, treating orthodontists are oftentimes required to vary the type of arch wire throughout a patient's treatment in order to achieve the advantages of the various types without incurring too many of the drawbacks. Currently, orthodontists typically choose between round and rectangular arch wires.

Circular or round arch wires are commonly used in the art. Round arch wires are desirable because they are relatively flexible and offer low friction. Round wires, thus, are more easily conformed to the patient's mouth. Round wires, however, are unable to apply torquing forces on the patient's teeth. A further disadvantage of round wires is their poor control of rotational forces on the patient's molars. Because round wires do not completely fill in the slots in molar brackets in the bucco-lingual dimension, the play between the wire and bracket allows undesirable rotation forces to be exerted on the molar.

Rectangular wires are also commonly used in the art and offer certain advantages and disadvantages. Rectangular wires offer greater stiffness in comparison to round wires. Rectangular wires, also, offer the advantage of providing torquing capabilities. Rectangular wires also minimize the rotational forces placed on molars because of their ability to completely fill in the slots in the molar brackets bucco-lingually. The main problem with rectangular wires, however, is the undesirable friction which is imparted on the brackets.

Other configurations of arch wire have been developed in the art in order to improve upon the prior art. U.S. Pat. No. 5,468,147 to Yao, for example, discloses an arch wire having an X-shaped cross-section. Yao, thus, discloses an arch wire that is more flexible than standard square or rectangular arch wires, but still retains the ability to apply torquing force, which is absent in a round wire.

Other such configurations are disclosed by U.S. Pat. No. 4,186,487 to Wallshein. Wallshein's patent discloses orthodontic arch wires comprising multiple strands of material that are loosely helically wound. Wallshein's patent discloses stranded arch wires that allow advantages (such as torquing) of rectangular wires while maintaining the flexibility of round wires. Wallshein's patent, meanwhile, also discloses the use of oval shaped strands within a round wire in order to allow a greater degree of flexibility. Modern materials, such as Nickel-Titanium (“Ni—Ti”), however offer many of these advantages without the need for additional strands and the expense associated with more complicated manufacturing.

U.S. Pat. No. 1,938,428 to Johnson discloses an orthodontic bracket with an opening in the shape of an oval, which allows the insertion of a plurality of round arch wires into the oval opening in the bracket.

Another such configuration of arch wire is disclosed by U.S. Pat. No. 5,259,760 to Orikasa. Orikasa's patent discloses an orthodontic wire that is capable of exerting forces on the dental arch that gradually vary in magnitude along the wire. For example, the wire may feature a round cross section at certain points and a rectangular cross section at certain other points. The wire smoothly transitions among circular and square sections by featuring one or more oval or elliptical sections.

Other shapes of orthodontic wire are disclosed by U.S. Pat. No. 6,095,809 to Kelly et al. Kelly's patent discloses orthodontic arch wires of generally rectangular shapes and featuring rounded corners. The advantages claimed by Kelly are an arch wire of reduced stiffness that is capable of controlling torquing. Such wires are also advantageous because the rounded edges allow that they may be more easily inserted and removed from self-ligating orthodontic brackets.

Another such configuration of arch wire is disclosed by U.S. Pat. No. 6,811,397 to Wool. Wool's patent discloses the use of multiple sections of arch wire, having different cross-sectional shapes, connected to one another. Sections of square cross sectional wire, for example, may be attached to round sections of wire by using hollow connectors. In various embodiments of Wool's invention, the connectors are oval in shape.

Other configurations of arch wire are disclosed by U.S. Patent Application No. 2006/0121406 by Vogt. Vogt's patent application discloses the use of tubular materials composed of super-elastic nickel titanium alloy. Various embodiments of the invention features a plurality of holes throughout the wire in order to reduce the force exerted by the wire. Vogt's patent application claims an orthodontic arch wire that provides a lighter engagement force and, yet, has sufficient dimension to completely fill the slots of the orthodontic brackets. Another object of Vogt's invention is to provide a tube that can be compressed in the direction of the cross sectional dimension and may recover to its original shape. Vogt claims wires in round, square, and oval shaped tubular configurations.

There, however, remains a long felt need in the art for an orthodontic arch wire that combines the benefit of various prior art wires in order that the wire may supply stiffness, low friction, minimizes rotational forces to the molar, ease of engagements with brackets currently used in the art, and further such advantages.

### SUMMARY OF THE INVENTION

Various embodiments of the invention are directed towards improving upon the prior art by disclosing an orthodontic arch wire that combines the benefit of various prior art wires in order that the wire may supply stiffness, low friction, minimizes rotational forces to the molar, ease of engagements with brackets currently used in the art, and further such advantages into a single wire. Various embodiments of the invention are directed towards overcoming the shortcomings in the prior art by disclosing an orthodontic arch wire having an oval or elliptical cross section. The oval cross section, in various embodiments of the invention, features two axes of symmetry, in order that it may comprise an ellipse. The major axis of the ellipse, in various embodiments of the invention, is configured to be generally perpendicular to the face of the tooth.

By configuring the major axis of the ellipse to be generally perpendicular to the face of the tooth, the arch wire allows greater stiffness than comparable round arch wires. Thus, the ellipse shaped arch wire achieves many of the stiffness benefits of rectangular wires. Meanwhile, because the elliptical arch wire does not feature flat surfaces, it does not impart torquing forces in the manner that is done by rectangle shaped arch wires.

The elliptical shaped wire, meanwhile, allows the orthodontist to use sliding mechanics in order to correct malocclusions of the teeth. The elliptical shaped wire is ideal for such applications because it controls the arch shape through stiffness without the friction created by rectangular shaped arch wires. Round wire achieves low friction because of the relatively small surface area that comes into contact with the bracket, relative to rectangular wire. Elliptical wire achieves a similar point contact as round wire and, thus, affords the advantages of round wire in terms of low friction. Thus, the elliptical wire represents a substantial improvement on prior art systems because of the added stiffness allowed without the friction typically found in rectangular wires.

The elliptical shaped wire is compatible with existing self-ligating and standard brackets. Because the elliptical shaped wire features rounded edges, it may easily be applied to self-ligating brackets. Also, the elliptical shaped wire is usable with existing molar brackets, while being easily installed and applying relatively low rotational forces to the molar. The elliptical arch wire fills a relatively large portion of the slot in the molar bracket bucco-lingually opening in comparison to round wires and, thus, results in less rotational force being imparted on the molar.

The ratio of major axis to minor axis in various embodiments of the elliptical shaped wire may vary, depending on the orthodontist's desired application. A more massive wire, with a greater major axis, imparts greater stiffness to the patient's brackets through better control of the arch form. Some of the ratios of minor to major axis claimed by this disclosure include 14:25; 19:25; 21:25; 16:22; 18:22; 18:25; 17:25, and other such dimensions.

The principles of the invention may be practices with many types of orthodontic wires known in the art including, stainless steel orthodontic wire, nickel-titanium alloy orthodontic wire, multi-strand orthodontic wire, titanium memory alloy orthodontic wire, heat activated allow orthodontic wire, beta-titanium wire, and other such orthodontic wires known in the art.

While the use of oval shaped orthodontic devices is disclosed in the prior art, this disclosure represents a substantial improvement and departure from the prior art. As discussed above, for example, U.S. Pat. No. 1,983,428 too Johnson discloses the use of an oval shaped opening in order to receive multiple round arch wires. Johnson's patent fails, however, to disclose the use of arch wires that are oval in cross-sectional shape. Similarly, U.S. Pat. No. 6,811,397 to Wool discloses the use of hollow connectors to square and round arch wire sections that may be oval in cross section. Neither patent, however, discloses the use of a arch wire having an oval cross-section.

Wallshein's patent (U.S. Pat. No. 4,186,487), likewise, discloses the use of oval-shaped strands within the arch wire. Wallshein's patent, however, fails to disclose the use of an arch wire having an oval cross section. U.S. Pat. No. 5,259,760 to Orisaka discloses an arch wire that features multiple cross-sectional shapes. In some embodiments, Orisaka's arch wire may feature a portion that is oval in cross-section. Orisaka, however, fails to disclose the use of an arch wire that is entirely oval in cross-section. More importantly, Orisaka's arch wire is incapable of providing the advantages of an oval shaped arch wire whose major axis is orientated perpendicularly to the face of the tooth.

While Vogt's patent application (U.S. Patent Application No. 2006/0121406) discloses the use of an entirely oval shaped wire, it fails to disclose many of the advantages outlined above. For example, Vogt's patent is directed to a hollow, tube-shaped arch wire and does not disclose an oval-shaped solid wire. Because of the reduced material in such a wire, an oval shaped configuration would not allow a substantial amount of stiffness, in the manner of the disclosed invention. As a matter of fact, Vogt's arch wire is intended to impart less force. Furthermore, Vogt's arch wire is configured to compress in the direction of the cross-sectional dimension. Thus, Vogt's arch wire entirely fills the orthodontic bracket while supplying reduced force levels. Various embodiments of the invention improve upon arch wires such as Vogt's by allowing greater forces (as conveyed by rectangular wires) while maintaining many of the advantages of round wires.

Thus, the elliptical shaped arch wire of various embodiments of the invention allow a substantial improvement on the orthodontic arch wires of the prior art.

### BRIEF DESCRIPTION OF THE DRAWINGS

FIG. 1 is an illustration from a cross sectional view of a prior art round orthodontic arch wire while in an orthodontic bracket.

FIG. 2 is an illustration from a cross sectional view of a prior art rectangular orthodontic arch wire while in an orthodontic bracket.

FIG. 3 is an illustration from a top view of teeth, brackets, and an orthodontic arch wire while installed in a patient's mouth.

FIG. 4 is an illustration from a cross sectional view of the orthodontic arch wire in various embodiments of the invention while in an orthodontic bracket.

FIG. 5 is an illustration from a cross sectional view of the orthodontic arch wire in various embodiments of the invention while slightly outside an orthodontic bracket and showing the orientation of the arch wire relative to the bracket and face of the tooth.

FIG. 6 is an illustration from a cross sectional view of the orthodontic arch wire in various embodiments of the invention while slightly outside a self-ligating orthodontic bracket.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention. Various embodiments of the invention remain useable in tandem or combination of one another.

In the following description, certain terminology is used to describe certain features of one or more embodiments of the invention. For instance, “arch wire” refers to any of the various orthodontic arch wires known in the art including stainless steel, nickel-titanium, composite, stranded arch wires, or any other such orthodontic arch wire known in the art and “bracket” refers to any of the various orthodontic brackets, including self ligating brackets, “smart brackets”, known in the art.

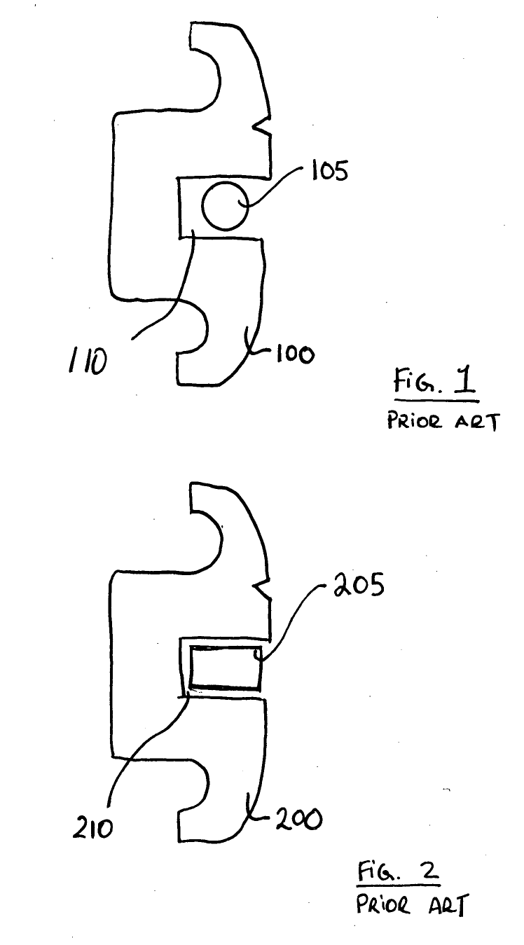

FIG. 1 is an illustration from a cross sectional view of a prior art round orthodontic arch wire while in an orthodontic bracket. FIG. 1 illustrates an orthodontic bracket 100 that features a cavity 110 into which a round orthodontic bracket 105 is placed. As discussed in greater detail above, round orthodontic brackets 105 are unable to apply torquing forces on the patient's teeth because they lack edges to apply pressure to the edges of the cavity 110. In order to impart torquing or coupling forces, generally, two or more points of contact are required. In the case of round wires, because only one point of contact is supplied, coupling or torquing forces are not imparted.

FIG. 2 is an illustration from a cross sectional view of a prior art rectangular orthodontic arch wire while in an orthodontic bracket. FIG. 2 illustrates an orthodontic bracket 200 that features a cavity 210 into which a rectangular orthodontic bracket 205 is placed. As discussed in greater detail above, rectangular orthodontic brackets 205 are advantageous because their edges come into contact with the cavity 210 walls and apply torquing forces to the teeth. The disadvantage of rectangular brackets is the higher friction which results from the increased contact with the brackets.

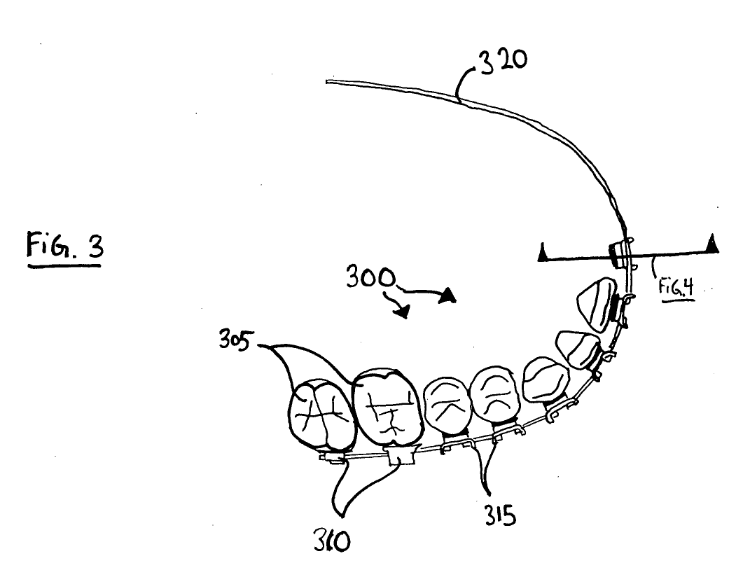

FIG. 3 is an illustration from a top view of teeth 300, brackets 315, and an orthodontic arch 320 wire while installed in a patient's mouth. FIG. 3 illustrates the molars 305 and molar brackets 310, which attach the end of the U-shaped orthodontic arch wire 320. The orthodontic arch wire 320 passes through cavities in the brackets 315 in order to apply pressure to the teeth 300.

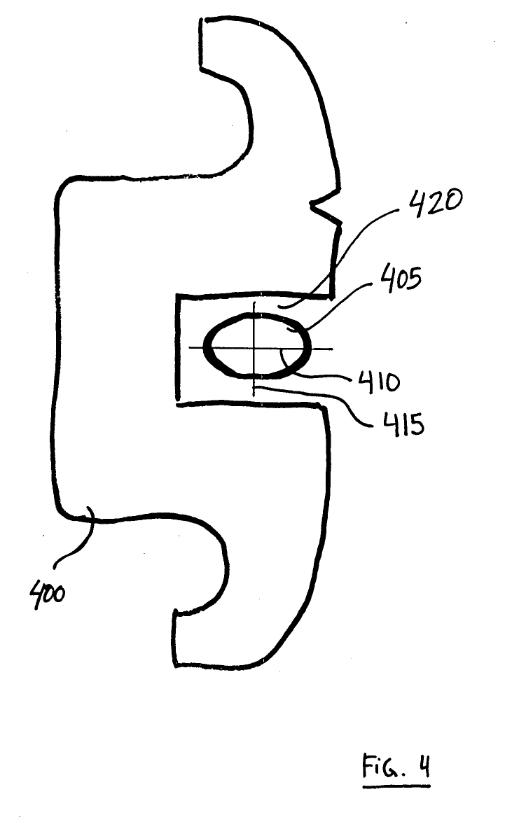

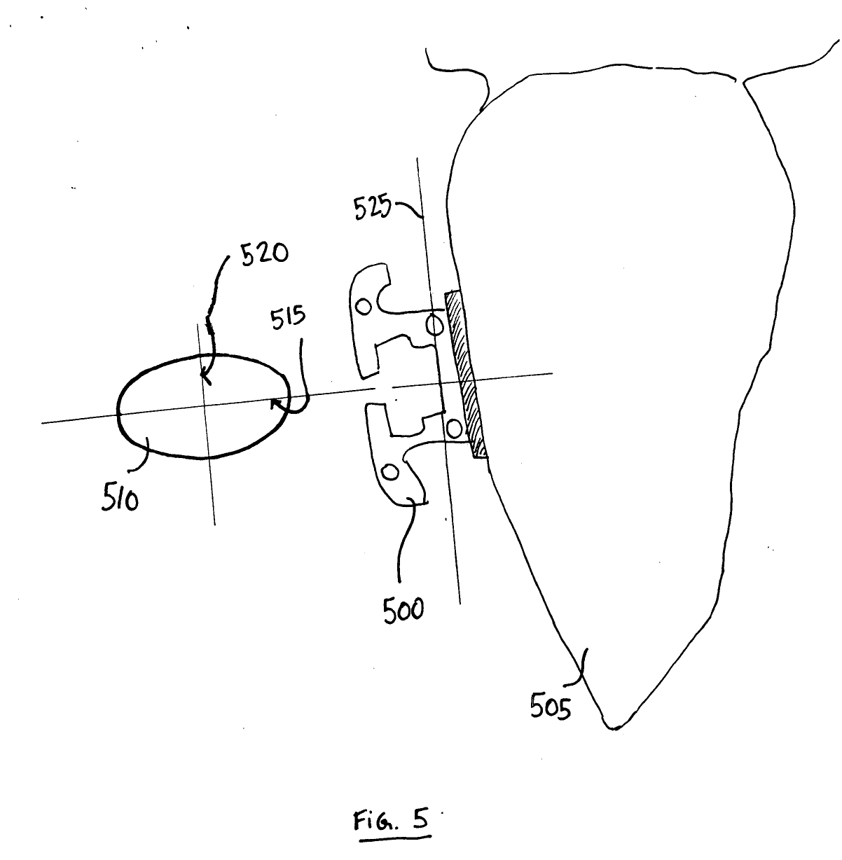

FIG. 4 is an illustration from a cross sectional view of the orthodontic arch wire 405 in various embodiments of the invention while placed within an orthodontic bracket 400. An oval shaped orthodontic arch wire 410 is illustrated while within the cavity 420 of an orthodontic bracket 400. The major axis 410 of the oval cross section is orientated generally perpendicularly to the face of the tooth. The minor axis 415 of the oval cross section is orientated parallel to the face of the tooth. In this manner, the arch wire allows the benefits of rectangular arch wires (such as greater stiffness) and the benefits of round arch wires (such as low friction) into a single wire. Thus, these various embodiments of the invention allow substantial improvements over the prior art arch wires discussed in FIGS. 1 and 2.

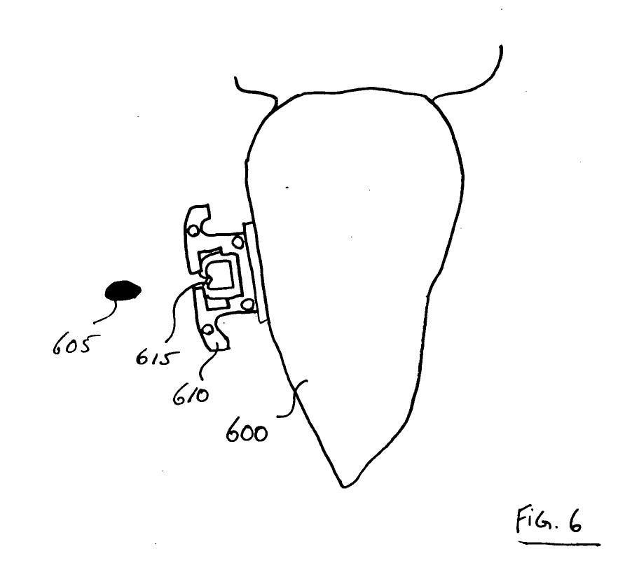

FIG. 5 is an illustration from a cross sectional view of the orthodontic arch wire 510 in various embodiments of the invention while slightly outside an orthodontic bracket 500 and showing the orientation of the arch wire relative to the bracket and face of the tooth 505. The major axis 515 of the oval shaped orthodontic arch wire 510 lies generally perpendicular to the plane of the face of the tooth 525. The minor axis 520 of the oval shaped orthodontic arch wire 510 lies parallel to the plane of the face of the tooth 525.

FIG. 6 is an illustration from a cross sectional view of the orthodontic arch wire 605 in various embodiments of the invention while slightly outside a self-ligating orthodontic bracket 610. The bracket 610 featuring a self-ligating mechanism 615 is attached to a tooth 600. The oval shaped orthodontic arch wire 605 in various embodiments of the invention is able to be inserted into the self-ligating mechanism 615 because it features rounded edges. Thus, another advantage of the arch wire in various embodiments of the invention is that it remains compatible with orthodontic brackets 610 featuring self-ligating mechanisms 615.

What is claimed is:

1. An orthodontic arch wire, comprising:
a generally U-shaped orthodontic arch wire,
said orthodontic arch wire having an elliptical cross sectional shape and said elliptical cross sectional shape having a major axis and a minor axis, said major axis being longer than said minor axis,
said orthodontic arch wire being configured such that, when said orthodontic arch wire is fit to a patient's mouth, said major axis lies generally perpendicularly to the face of a patient's teeth.

2. An orthodontic arch wire according to claim 1, wherein said orthodontic arch wire comprises a solid orthodontic arch wire.

3. An orthodontic arch wire according to claim 1, wherein said orthodontic arch wire comprises a stainless steel orthodontic arch wire.

4. An orthodontic arch wire according to claim 1, wherein said orthodontic arch wire comprises a nickel-titanium alloy orthodontic arch wire.

5. An orthodontic arch wire according to claim 1, wherein said orthodontic arch wire comprises a multi-strand orthodontic arch wire.

6. An orthodontic arch wire according to claim 1, wherein said orthodontic arch wire comprises a titanium memory alloy orthodontic arch wire.

7. An orthodontic arch wire according to claim 1, wherein said orthodontic arch wire comprises a heat activated alloy orthodontic arch wire.

8. An orthodontic arch wire according to claim 1, wherein said orthodontic arch wire comprises a beta-titanium orthodontic arch wire.

9. An orthodontic arch wire according to claim 1, wherein said orthodontic arch wire is compatible with self-ligating orthodontic brackets.

10. An orthodontic arch wire according to claim 1, wherein the ratio of said minor axis to said major axis is a ratio selected from the following ratios: 14:25; 19:25; 21:25; 16:22; 18:22; 18:25; or 17:25.

11. A method for supplying orthodontic treatment using an orthodontic arch wire wherein said orthodontic arch wire comprises,
a generally U-shaped orthodontic arch wire,
said orthodontic arch wire having an elliptical cross sectional shape and said elliptical cross sectional shape having a major axis and a minor axis, said major axis being longer than said minor axis,
said orthodontic arch wire being configured such that, when said orthodontic arch wire is fit to a patient's mouth, said major axis lies generally perpendicularly to the face of a patient's teeth.

12. A method for supplying orthodontic treatment using an orthodontic arch wire according to claim 11, wherein said orthodontic arch wire comprises a solid orthodontic arch wire.

13. A method for supplying orthodontic treatment using an orthodontic arch wire according to claim 11, wherein said orthodontic arch wire comprises a stainless steel orthodontic arch wire.

14. A method for supplying orthodontic treatment using an orthodontic arch wire according to claim 11, wherein said orthodontic arch wire comprises a nickel-titanium alloy orthodontic arch wire.

15. A method for supplying orthodontic treatment using an orthodontic arch wire according to claim 11, wherein said orthodontic arch wire comprises a multi-strand orthodontic arch wire.

16. A method for supplying orthodontic treatment using an orthodontic arch wire according to claim 11, wherein said orthodontic arch wire comprises a titanium memory alloy orthodontic arch wire.

17. A method for supplying orthodontic treatment using an orthodontic arch wire according to claim 11, wherein said orthodontic arch wire comprises a heat activated alloy orthodontic arch wire.

18. A method for supplying orthodontic treatment using an orthodontic arch wire according to claim 11, wherein said orthodontic arch wire comprises a beta-titanium orthodontic arch wire.

19. A method for supplying orthodontic treatment using an orthodontic arch wire according to claim 11, wherein said orthodontic arch wire is compatible with self-ligating orthodontic brackets.

20. A method for supplying orthodontic treatment using an orthodontic arch wire according to claim 11, wherein the ratio of said minor axis to said major axis is a ratio selected from the following ratios: 14:25; 19:25; 21:25; 16:22; 18:22; 18:25; or 17:25.
